(19) United States
(12) Patent Application Publication
(10) Pub. No.: US 2014/0357275 A1
(43) Pub. Date: Dec. 4, 2014

(54) CELL HANDOVER METHOD, USER EQUIPMENT AND BASE STATION

(71) Applicant: Huawei Technologies Co., Ltd., Shenzhen (CN)

(72) Inventors: Wei QUAN, Beijing (CN); Jian ZHANG, Beijing (CN)

(21) Appl. No.: 14/462,223

(22) Filed: Aug. 18, 2014

Related U.S. Application Data
(63) Continuation of application No. PCT/CN2013/071927, filed on Feb. 27, 2013.

(51) Int. Cl. H04W 36/00

(52) U.S. Cl. CPC H04W 36/0061; H04W 36/0094
USPC 455/436

(57) ABSTRACT

A cell handover method, a user equipment and a base station are disclosed. The method includes: obtaining, by a user equipment UE, a cell list and a measurement parameter that are configured by a serving base station, where the cell list includes at least one cell; performing, by the UE, cell measurement according to the measurement parameter to obtain a measurement result; when the measurement result includes a cell belonging to the cell list, selecting, by the UE, the cell belonging to the cell list from the measurement result to serve as a target cell; and handing over, by the UE, to the target cell. In embodiments of the present invention, when the UE is handed over to a cell in a free handover area, the number of signaling exchanges is decreased compared with an existing cell handover.

### CROSS-REFERENCE TO RELATED APPLICATIONS

This application is a continuation of International Patent Application No. PCT/CN2013/071927, filed on Feb. 27, 2013, which is hereby incorporated by reference in its entirety.

### TECHNICAL FIELD

The present invention relates to the field of communications technologies, and in particular, to a cell handover method, a user equipment (UE), and a base station.

### BACKGROUND

In a wireless communication system, when a UE moves from one cell (also referred to as a base station or a coverage area of a base station) to another cell, cell handover is required for the UE to keep communication continuity of the UE. In a 3rd Generation Partnership Project (3GPP) Long Term Evolution (LTE) system or an LTE-Advanced (LTE-A) system, assuming that a current serving base station of a UE is a source base station, and a base station to which the UE is to be handed over is a target base station, a typical procedure for a cell handover may include: configuring, by the source base station, a measurement parameter for the UE; measuring, by the UE, a serving cell and a neighboring cell according to the measurement parameter, and reporting a measurement result to the source base station; performing, by the source base station, handover determination according to the measurement report, determining the target base station, and sending a handover request to the target base station; when the target base station determines to accept the handover and after a handover parameter of the UE is sent to the source base station, sending, by the source base station, a handover command carrying the handover parameter to a terminal; and receiving, by the UE, the handover command, initiating a random access procedure to the target base station, and sending a handover complete message, thereby completing the procedure for the cell handover from the source base station to the target base station.

Research on the prior art finds that, with a diversity of networking forms in a wireless communication system, such as coordinated multiple point (COMP) networking, small cell networking (including a pico cell), and dense small cell networking, multiple cells are generally distributed in a certain geographic area, when a UE moves in the area, frequent cell handovers are required, and when a cell handover is performed according to the existing handover procedure, frequent signaling exchanges are required between a source base station and the UE and between the source base station and a target base station; therefore, handover signaling overheads of the system are large, and a large number of radio resources are occupied.

### SUMMARY

Embodiments of the present invention provide a cell handover method, a UE, and a base station, so as to solve a problem of large handover signaling overheads of a system in the prior art caused by a large number of radio resources occupied by frequent cell handovers.

In order to solve the foregoing technical problem, the embodiments of the present invention disclose the following technical solutions:

According to a first aspect, a UE is provided and the UE includes:

an obtaining unit, configured to obtain a cell list and a measurement parameter that are configured by a serving base station, where the cell list includes at least one cell;

a measuring unit, configured to perform cell measurement according to the measurement parameter to obtain a measurement result;

a selecting unit, configured to: when the measurement result includes a cell belonging to the cell list, select the cell belonging to the cell list from the measurement result to serve as a target cell; and a handover unit, configured to hand over the UE to the target cell.

With reference to the first aspect, in a first possible implementation manner of the first aspect, the UE further includes:

a sending unit, configured to: send a handover request message to the serving base station, where the handover request message includes a cell identity of the target cell, so that the serving base station sends, according to the cell identity, a handover request preparation message to a target base station to which the target cell belongs; or, send a measurement report message to the serving base station, where the measurement report message includes a measurement result of a cell belonging to the cell list, so that the serving base station selects from the measurement result a cell having a best measurement result to serve as the target cell of the UE, or selects from the measurement result a cell with a highest priority to serve as the target cell of the UE, and sends a handover request preparation message to a target base station to which the target cell belongs.

With reference to the first possible implementation manner of the first aspect, in a second possible implementation manner of the first aspect, the UE further includes:

a receiving unit, configured to receive a handover command generated by the target base station according to the handover request preparation message, where

the handover unit is specifically configured to access the target cell after the handover command is received, or access the target cell after the handover command is received and a handover complete message is sent to the target cell.

With reference to the first aspect, or the first possible implementation manner of the first aspect, or the second possible implementation manner of the first aspect, in a third possible implementation manner of the first aspect, the obtaining unit is specifically configured to obtain the cell list and the measurement parameter that are configured by the serving base station from one message delivered by the serving base station, or obtain the cell list and the measurement parameter that are configured by the serving base station from different messages delivered by the serving base station.

With reference to the first aspect, or the first possible implementation manner of the first aspect, or the second possible implementation manner of the first aspect, or the third possible implementation manner of the first aspect, in a fourth possible implementation manner of the first aspect, the selecting unit includes:

a first selecting subunit, configured to select from the measurement result a cell that meets a trigger condition and belongs to the cell list; and

a second selecting subunit, configured to: when the cell selected by the first selecting subunit includes one cell, use the cell as the target cell of the UE; when the cell selected by the first selecting subunit includes multiple cells, select a cell having a best measurement result from the multiple cells to serve as the target cell of the UE, or select a cell with a highest priority from the multiple cells to serve as the target cell of the UE.

With reference to the first aspect, or the first possible implementation manner of the first aspect, or the second possible implementation manner of the first aspect, or the third possible implementation manner of the first aspect, or the fourth possible implementation manner of the first aspect, in a fifth possible implementation manner of the first aspect, the handover unit includes at least one of the following subunits:

a first handover subunit, configured to hand over the UE to the target cell in a random access manner;

a second handover subunit, configured to directly hand over the UE to the target cell;

a third handover subunit, configured to hand over the UE to the target cell by sending a scheduling request (SR); and

a fourth handover subunit, configured to hand over the UE to the target cell by sending a Layer 2 message or a Layer 3 message to the target cell.

According to a second aspect, a base station is provided, where the base station is used as a serving base station of a UE, and the base station includes:

a configuring unit, adapted to configure a cell list and a measurement parameter for the UE, where the cell list includes at least one cell; and

a delivering unit, configured to deliver the cell list and the measurement parameter to the UE, so that the UE performs cell measurement according to the measurement parameter to obtain a measurement result, and when the measurement result includes a cell belonging to the cell list, the UE selects the cell belonging to the cell list from the measurement result to serve as a target cell, and the UE is handed over to the target cell.

With reference to the second aspect, in a first possible implementation manner of the second aspect, the base station further includes:

a first receiving unit, configured to receive a handover request message sent by the UE, where the handover request message is a message sent by the UE to the serving base station after the target cell is obtained, and the handover request message includes a cell identity of the target cell; and

a first sending unit, configured to send, according to the cell identity of the target cell, a handover request preparation message to a target base station to which the target cell belongs.

With reference to the second aspect, in a second possible implementation manner of the second aspect, the base station further includes:

a second receiving unit, configured to receive a measurement report message sent by the UE, where the measurement report message includes a measurement result of a cell belonging to the cell list;

a selecting unit, configured to select from the measurement result a cell having a best measurement result to serve as the target cell of the UE, or select from the measurement result a cell with a highest priority to serve as the target cell of the UE; and

a second sending unit, configured to send a handover request preparation message to a target base station to which the target cell belongs.

With reference to the second aspect, in a third possible implementation manner of the second aspect, the base station further includes:

a third sending unit, configured to send a handover request preparation message to a base station to which a cell in the cell list belongs; and

a third receiving unit, configured to receive a handover indication message, which is sent by a target base station to which the target cell belongs after the handover request preparation message is received, where the handover indication message is used to indicate that the UE has accessed the target cell.

With reference to the second aspect, or the first possible implementation manner of the second aspect, or the second possible implementation manner of the second aspect, or the third possible implementation manner of the second aspect, in a fourth possible implementation manner of the second aspect, the configuring unit includes:

a load information obtaining subunit, configured to obtain load information of each cell;

a load threshold determining subunit, configured to determine whether load of each cell exceeds a set load threshold according to the load information; and

a cell list configuring subunit, configured to add, according to a determination result, a cell whose load does not exceed the load threshold to the cell list.

According to a third aspect, a cell handover method is provided and the method includes:

obtaining, by a user equipment UE, a cell list and a measurement parameter that are configured by a serving base station, where the cell list includes at least one cell;

performing, by the UE, cell measurement according to the measurement parameter to obtain a measurement result;

when the measurement result includes a cell belonging to the cell list, selecting, by the UE, the cell belonging to the cell list from the measurement result to serve as a target cell; and

handing over, by the UE, to the target cell.

With reference to the third aspect, in a first possible implementation manner of the third aspect, before the handing over, by the UE, to the target cell, the method further includes:

sending, by the UE, a handover request message to the serving base station, where the handover request message includes a cell identity of the target cell, so that the serving base station sends, according to the cell identity, a handover request preparation message to a target base station to which the target cell belongs; or,

sending, by the UE, a measurement report message to the serving base station, where the measurement report message includes a measurement result of a cell belonging to the cell list, so that the serving base station selects from the measurement result a cell having a best measurement result to serve as the target cell of the UE, or selects from the measurement result a cell with a highest priority to serve as the target cell of the UE, and sends a handover request preparation message to a target base station to which the target cell belongs.

With reference to the first possible implementation manner of the third aspect, in a second possible implementation manner of the third aspect, the method further includes: receiving, by the UE, a handover command generated by the target base station according to the handover request preparation message; and

the handing over, by the UE, to the target cell includes: accessing, by the UE, the target cell after the UE receives the handover command, or accessing, by the UE, the target cell after the UE receives the handover command and sends a handover complete message to the target cell.

With reference to the third aspect, or the first possible implementation manner of the third aspect, or the second possible implementation manner of the third aspect, in a third possible implementation manner of the third aspect, the obtaining, by a UE, a cell list and a measurement parameter that are configured by a serving base station includes:

obtaining, by the UE, the cell list and the measurement parameter that are configured by the serving base station from one message delivered by the serving base station; or

obtaining, by the UE, the cell list and the measurement parameter that are configured by the serving base station from different messages delivered by the serving base station.

With reference to the third aspect, or the first possible implementation manner of the third aspect, or the second possible implementation manner of the third aspect, or the third possible implementation manner of the third aspect, in a fourth possible implementation manner of the third aspect, the measurement parameter includes a trigger condition for handing over the UE to a cell in the cell list; and

the selecting, by the UE, the cell belonging to the cell list from the measurement result to serve as a target cell includes:

selecting, by the UE from the measurement result, a cell that meets the trigger condition and belongs to the cell list; and

when the selected cell includes one cell, using the cell as the target cell of the UE; when the selected cell includes multiple cells, selecting a cell having a best measurement result from the multiple cells to serve as the target cell of the UE, or selecting a cell with a highest priority from the multiple cells to serve as the target cell of the UE.

With reference to the third aspect, or the first possible implementation manner of the third aspect, or the second possible implementation manner of the third aspect, or the third possible implementation manner of the third aspect, or the fourth possible implementation manner of the third aspect, in a fifth possible implementation manner of the third aspect, the UE is handed over to the target cell by using at least one of the following manners:

the UE is handed over to the target cell in a random access manner;

the UE is directly handed over to the target cell;

the UE is handed over to the target cell by sending a scheduling request SR; and

the UE is handed over to the target cell by sending a Layer 2 message or a Layer 3 message to the target cell.

According to a fourth aspect, another cell handover method is provided and the method includes:

configuring, by a serving base station, a cell list and a measurement parameter for a UE, where the cell list includes at least one cell; and

delivering, by the serving base station, the cell list and the measurement parameter to the UE, so that the UE performs cell measurement according to the measurement parameter to obtain a measurement result, and when the measurement result includes a cell belonging to the cell list, the UE selects the cell belonging to the cell list from the measurement result to serve as a target cell, and the UE is handed over to the target cell.

With reference to the fourth aspect, in a first possible implementation manner of the fourth aspect, the method further includes:

receiving, by the serving base station, a handover request message sent by the UE, where the handover request message is a message sent by the UE to the serving base station after the target cell is obtained, and the handover request message includes a cell identity of the target cell; and

sending, by the serving base station according to the cell identity of the target cell, a handover request preparation message to a target base station to which the target cell belongs.

With reference to the fourth aspect, in a second possible implementation manner of the fourth aspect, the method further includes:

receiving, by the serving base station, a measurement report message sent by the UE, where the measurement report message includes a measurement result of a cell belonging to the cell list;

selecting, by the serving base station from the measurement result, a cell having a best measurement result to serve as the target cell of the UE, or selecting from the measurement result a cell with a highest priority to serve as the target cell of the UE; and sending, by the serving base station, a handover request preparation message to a target base station to which the target cell belongs.

With reference to the fourth aspect, in a third possible implementation manner of the fourth aspect, the method further includes:

sending, by the serving base station, a handover request preparation message to a base station to which a cell in the cell list belongs; and

receiving a handover indication message, which is sent by a target base station to which the target cell belongs after the handover request preparation message is received, where the handover indication message is used to indicate that the UE has accessed the target cell.

With reference to the fourth aspect, or the first possible implementation manner of the fourth aspect, or the second possible implementation manner of the fourth aspect, or the third possible implementation manner of the fourth aspect, in a fourth possible implementation manner of the fourth aspect, the configuring, by a serving base station, a cell list for a UE includes:

obtaining, by the serving base station, load information of each cell;

determining whether load of each cell exceeds a set load threshold according to the load information; and

adding, according to a determination result, a cell whose load does not exceed the load threshold to the cell list.

According to a fifth aspect, another UE is provided and the UE includes a radio transceiver and a processor, where

the radio transceiver is configured to obtain a cell list and a measurement parameter that are configured by a serving base station, where the cell list includes at least one cell; and

the processor is configured to perform cell measurement according to the measurement parameter to obtain a measurement result, and when the measurement result includes a cell belonging to the cell list, select the cell belonging to the cell list from the measurement result to serve as a target cell, and hand over the UE to the target cell.

With reference to the fifth aspect, in a first possible implementation manner of the fifth aspect, the radio transceiver is further configured to: send a handover request message to the serving base station, where the handover request message includes a cell identity of the target cell, so that the serving base station sends, according to the cell identity, a handover request preparation message to a target base station to which the target cell belongs; or, send a measurement report message to the serving base station, where the measurement report message includes a measurement result of a cell belonging to the cell list, so that the serving base station selects from the measurement result a cell having a best measurement result to serve as the target cell of the UE, or selects from the measurement result a cell with a highest priority to serve as the target cell of the UE, and sends a handover request preparation message to a target base station to which the target cell belongs.

With reference to the first possible implementation manner of the fifth aspect, in a second possible implementation manner of the fifth aspect, the radio transceiver is further configured to receive a handover command generated by the target base station according to the handover request preparation message; and the processor is specifically configured to access the target cell after the handover command is received, or access the target cell after the handover command is received and a handover complete message is sent to the target cell.

With reference to the fifth aspect, or the first possible implementation manner of the fifth aspect, or the second possible implementation manner of the fifth aspect, in a third possible implementation manner of the fifth aspect, the radio transceiver is specifically configured to obtain the cell list and the measurement parameter that are configured by the serving base station from one message delivered by the serving base station, or obtain the cell list and the measurement parameter that are configured by the serving base station from different messages delivered by the serving base station.

With reference to the fifth aspect, or the first possible implementation manner of the fifth aspect, or the second possible implementation manner of the fifth aspect, or the third possible implementation manner of the fifth aspect, in a fourth possible implementation manner of the fifth aspect, the processor is specifically configured to: select from the measurement result a cell that meets a trigger condition and belongs to the cell list; when the selected cell includes one cell, use the cell as the target cell of the UE, and when the selected cell includes multiple cells, select from the multiple cells a cell having a best measurement result to serve as the target cell of the UE, or select from the multiple cells a cell with a highest priority to serve as the target cell of the UE.

With reference to the fifth aspect, or the first possible implementation manner of the fifth aspect, or the second possible implementation manner of the fifth aspect, or the third possible implementation manner of the fifth aspect, or the fourth possible implementation manner of the fifth aspect, in a fifth possible implementation manner of the fifth aspect, the processor performs a handover to the target cell by using at least one of the following manners:

the processor performs a handover to the target cell in a random access manner;

the processor directly performs a handover to the target cell;

the processor performs a handover to the target cell by sending a scheduling request SR; and

the processor performs a handover to the target cell by sending a Layer 2 message or a Layer 3 message to the target cell.

According to a sixth aspect, another base station is provided, where the base station is used as a serving base station of a UE, and the base station includes: a transceiver and a processor, where

the processor is configured to configure a cell list and a measurement parameter for the UE, where the cell list includes at least one cell; and the transceiver is configured to deliver the cell list and the measurement parameter to the UE, so that the UE performs cell measurement according to the measurement parameter to obtain a measurement result, and when the measurement result includes a cell belonging to the cell list, the UE selects the cell belonging to the cell list from the measurement result to serve as a target cell, and the UE is handed over to the target cell.

With reference to the sixth aspect, in a first possible implementation manner of the sixth aspect, the transceiver is further configured to: receive a handover request message sent by the UE, where the handover request message is a message sent by the UE to the serving base station after the target cell is obtained, and the handover request message includes a cell identity of the target cell, and send, according to the cell identity of the target cell, a handover request preparation message to a target base station to which the target cell belongs.

With reference to the sixth aspect, in a second possible implementation manner of the sixth aspect, the transceiver is further configured to receive a measurement report message sent by the UE, where the measurement report message includes a measurement result of a cell belonging to the cell list;

the processor is further configured to select from the measurement result a cell having a best measurement result to serve as the target cell of the UE, or select from the measurement result a cell with a highest priority to serve as the target cell of the UE; and the transceiver is further configured to send a handover request preparation message to a target base station to which the target cell belongs.

With reference to the sixth aspect, in a third possible implementation manner of the sixth aspect, the transceiver is further configured to send a handover request preparation message to a base station to which a cell in the cell list belongs, and receive a handover indication message, which is sent by a target base station to which the target cell belongs after the handover request preparation message is received, where the handover indication message is used to indicate that the UE has accessed the target cell.

With reference to the sixth aspect, or the first possible implementation manner of the sixth aspect, or the second possible implementation manner of the sixth aspect, or the third possible implementation manner of the sixth aspect, in a fourth possible implementation manner of the sixth aspect, the processor is specifically configured to: obtain load information of each cell, determine whether load of each cell exceeds a set load threshold according to the load information, and add, according to a determination result, a cell whose load does not exceed the load threshold to the cell list.

In the embodiments of the present invention, a UE obtains a cell list and a measurement parameter that are configured by a serving base station, where the cell list includes at least one cell; the UE performs cell measurement according to the measurement parameter to obtain a measurement result; when the measurement result includes a cell belonging to the cell list, the UE selects the cell belonging to the cell list from the measurement result to serve as a target cell; and the UE is handed over to the target cell. In the embodiments of the present invention, when the UE is handed over to a cell in a free handover area, the number of signaling exchanges between the serving base station of the UE and the UE and between the serving base station of the UE and a target base station is decreased compared with an existing cell handover, which therefore saves signaling overheads of a system, reduces radio resources occupied by a large number of signaling overheads, and improves efficiency of a cell handover.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1A is a schematic diagram of a typical scenario of an application of a cell handover embodiment according to the present invention;

FIG. 1B is a flowchart of an embodiment of a cell handover method according to the present invention;

FIG. 1C is a flowchart of another embodiment of a cell handover method according to the present invention;

FIG. 2 is a flowchart of another embodiment of a cell handover method according to the present invention;

FIG. 3 is a flowchart of another embodiment of a cell handover method according to the present invention;

FIG. 4 is a flowchart of another embodiment of a cell handover method according to the present invention;

FIG. 5 is a block diagram of an embodiment of a UE according to the present invention;

FIG. 6 is a block diagram of another embodiment of a UE according to the present invention;

FIG. 7 is a block diagram of an embodiment of a base station according to the present invention; and

FIG. 8 is a block diagram of another embodiment of a base station according to the present invention.

### DESCRIPTION OF EMBODIMENTS

The following embodiments of the present invention provide a cell handover method, a UE and a base station, so as to simplify a cell handover procedure, and save system signaling overheads and radio resources.

To make a person skilled in the art understands technical solutions in the embodiments of the present invention better, and to make the foregoing objectives, features and advantages of the embodiments of the present invention clearer and more comprehensible, the following describes the technical solutions in the embodiments of the present invention in further detail with reference to the accompanying drawings.

It should be understood that, the technical solutions in the embodiments of the present invention may be applied to various communications systems, such as: a Global System for Mobile Communications (GSM) system, a Code Division Multiple Access (CDMA) system, a Wideband Code Division Multiple Access (WCDMA) system, a general packet radio service (GPRS) system, a Long Term Evolution (LTE) system, and a Universal Mobile Telecommunications System (UMTS).

A user equipment (UE) may also be referred to as a user, a mobile user equipment, a mobile terminal, and the like, and may communicate with one or more core networks by using a radio access network (RAN). The user may be a mobile terminal, such as a mobile phone (or referred to as a “cellular” phone) or a computer having a mobile terminal, for example, may be a portable, pocket-sized, handheld, computer built-in or vehicle-mounted mobile apparatus, which exchanges voice and/or data with the radio access network.

A base station may be a base station (BTS) in GSM or CDMA, may also be a base station (NodeB) in WCDMA, and may further be an evolved base station (e-NodeB) in LTE.

For ease of description, the following embodiments are described by using an LTE system as an example.

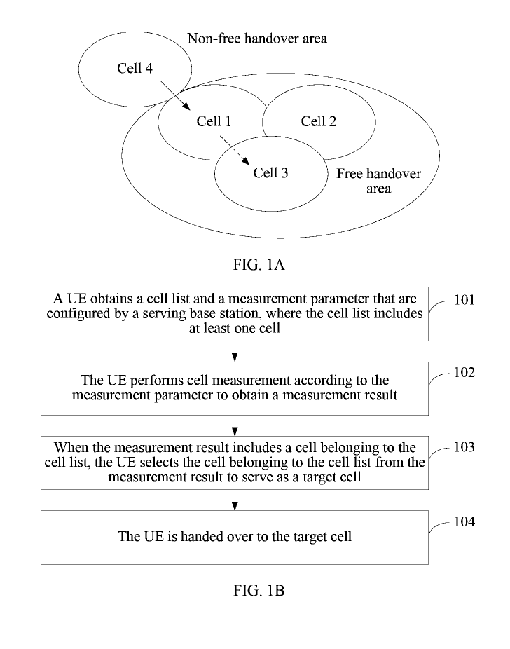

Referring to FIG. 1A, FIG. 1A is a schematic diagram of a typical scenario of an application of a cell handover embodiment according to the present invention.

FIG. 1A shows a free handover area to which an embodiment of the present invention is applied, where the free handover area may include multiple cells, and the cells may be neighboring cells or overlapping cells. The cells may specifically be macro cells, micro cells, pico cells, or the like. FIG. 1A exemplarily shows three cells that overlap with each other, namely, a cell 1, a cell 2, and a cell 3. In this embodiment, the cells in the free handover area may be configured flexibly as required, that is, the free handover area may include at least one cell, and each cell in the free handover area may share its respective load information, physical resources, and the like. A cell may be indicated by using cell identity information, and the cell identity information may specifically be a physical cell identity (PCI), a cell global identity (CGI), or the like.

When a UE moves between cells in the free handover area shown in FIG. 1A, or the UE moves from a cell in a non-free handover area to a cell in the free handover area shown in FIG. 1A, the UE may use a cell handover embodiment provided in the embodiment of the present invention to implement a cell handover. The cell handover embodiment of the present invention is described in detail with reference to the application scenario shown in FIG. 1A.

Referring to FIG. 1B, FIG. 1B is a flowchart of an embodiment of a cell handover method according to the present invention, and the embodiment describes a cell handover process from a UE aspect.

Step 101: A UE obtains a cell list and a measurement parameter that are configured by a serving base station, where the cell list includes at least one cell.

In this embodiment, the serving base station is a base station that is currently accessed by the UE and provides an uplink and downlink data transmission service for the UE. In this embodiment, the serving base station and a target base station may both be base stations in a free handover area; or the serving base station is a base station in a non-free handover area, and the target base station is a base station in the free handover area. The UE may obtain, from one message delivered by the serving base station, the cell list and the measurement parameter that are configured by the serving base station; or the UE may also obtain, from different messages delivered by the serving base station, the cell list and the measurement parameter that are configured by the serving base station. The cell list may include at least one cell in the free handover area, where a cell may be indicated by using cell identity information, and the cell identity information may specifically be a physical cell identity (PCI), a cell global identity (CGI), or the like.

Optionally, when configuring the cell list, the serving base station may further configure a priority sequence of cells in the cell list, so that the UE selects an eligible target cell according to the cell priority sequence; optionally, when configuring the cell list, the serving base station may further configure a priority sequence of executing a normal handover process or a free handover process, so that when cells in a subsequent measurement result that meet a handover condition include both a cell in the free handover area and a cell in the non-free handover area, a handover in the free handover area may be executed preferentially.

Optionally, the measurement parameter may include a trigger condition for handing over the UE to a cell in the free handover area. The trigger condition may specifically refer to that: the measurement parameter includes a trigger condition for handing over the UE between cells in the free handover area, or a trigger condition for handing over the UE from a cell in the non-free handover area to a cell in the free handover area. Optionally, the trigger condition for handing over the UE to a cell in the free handover area may be the same as or different from a trigger condition for measurement reporting in the prior art.

Step 102: The UE performs cell measurement according to the measurement parameter to obtain a measurement result.

In this embodiment, the measurement parameter configured by the serving base station for the UE may further include a trigger condition, in addition to a parameter consistent with that in the prior art for the UE to perform the cell measurement. The measurement parameter may include information such as a measurement object, a measurement item, and a measurement reporting condition, and the process in which the UE performs the cell measurement according to the parameters and obtains the measurement result is consistent with that in the prior art, which is not described herein again.

Step 103: When the measurement result includes a cell belonging to the cell list, the UE selects the cell belonging to the cell list from the measurement result to serve as a target cell.

In this embodiment, when the measurement result includes one cell that belongs to the cell list, the cell is used as the target cell; when the measurement result includes multiple cells that belong to the cell list, the UE may select a cell having a best measurement result from the multiple cells to serve as the target cell of the UE, or select, according to a cell priority configured by the base station, a cell with a highest priority from the multiple cells to serve as the target cell of the UE.

Optionally, when the measurement parameter further includes the trigger condition, the UE may: select a cell meeting the trigger condition and belonging to the cell list from the measurement result; when the selected cell includes one cell, use the cell as the target cell of the UE, and when the selected cell includes multiple cells, select a cell having a best measurement result from the multiple cells to serve as the target cell of the UE, or select a cell with a highest priority from the multiple cells to serve as the target cell of the UE. Specifically, the UE may: compare a measurement result of each cell with the trigger condition, obtain a first cell set formed by a cell that corresponds to the measurement result meeting the trigger condition, obtain a cell identity belonging to the cell list from a cell identity of the first cell set, and form a second cell set by using a cell that corresponds to the cell identity belonging to the cell list; when the second cell set includes one cell, use the cell as the target cell of the UE, and when the second cell set includes multiple cells, select a cell having a best measurement result from the multiple cells to serve as the target cell of the UE, or select, according to a cell priority configured by the base station, a cell with a highest priority from the multiple cells to serve as the target cell of the UE. Alternatively, the UE may also first determine whether each cell in the measurement result belongs to the cell list, form a second cell set by using a cell belonging to the cell list, compare each cell in the second cell set with the trigger condition, obtain a first cell set formed by a cell meeting the trigger condition; when the first cell set includes one cell, use the cell as the target cell of the UE, and when the first cell set includes multiple cells, select a cell having a best measurement result from the multiple cells to serve as the target cell of the UE, or select, according to a cell priority configured by the base station, a cell with a highest priority from the multiple cells to serve as the target cell of the UE.

Step 104: The UE is handed over to the target cell.

In this embodiment, when the UE is handed over to the target cell, a handover manner in the prior art may be used, where the UE and the target base station, where the target cell is located, perform downlink synchronization and uplink synchronization respectively, and after receiving an uplink resource allocated by the target base station, the UE sends a handover complete message to the target base station, thereby completing a handover to the target cell. In addition to the handover manner in the prior art, in this embodiment, the UE may also be handed over to the target cell in a random access manner, or may also be directly handed over to the target cell, or may also be handed over to the target cell by sending a scheduling request (SR), or in conjunction with the random access manner or the manner of sending an SR, may be handed over to the target cell by sending a Layer 2 message (such as a MAC message) or a Layer 3 message (such as an RRC message) to the target cell.

In addition, when the measurement result does not include any cell belonging to the cell list, the UE may execute an existing handover method, which is not described again in the embodiment of the present invention.

It can be seen from the foregoing embodiment that, when the UE is handed over to a cell in the free handover area, compared with an existing cell handover, the number of signaling exchanges between the UE and the serving base station is decreased, and the UE does not need to receive a handover command or report a measurement report, which therefore save air interface resources, reduce signaling overheads of a system, and improve efficiency of a cell handover.

Referring to FIG. 1C, FIG. 1C is a flowchart of another embodiment of a cell handover method according to the present invention, and the embodiment describes a cell handover process from a serving base station aspect.

Step 111: A serving base station configures a cell list and a measurement parameter for a UE, where the cell list includes at least one cell.

In this embodiment, the serving base station may obtain load information of each cell in a free handover area, determine whether load of each cell exceeds a set load threshold according to the load information, and add, according to a determination result, a cell whose load does not exceed the load threshold to the cell list.

Optionally, when configuring the cell list, the serving base station may further configure a priority sequence of cells in the cell list, so that the UE selects an eligible target cell according to the cell priority sequence; optionally, when configuring the cell list, the serving base station may further configure a priority sequence of executing a normal handover process or a free handover process, so that when cells in a subsequent measurement result that meet a handover condition include both a cell in the free handover area and a cell in the non-free handover area, a handover in the free handover area may be executed preferentially.

Optionally, the measurement parameter may include a trigger condition for handing over the UE to a cell in the free handover area. The trigger condition may specifically refer to that: the measurement parameter includes a trigger condition for handing over the UE between cells in the free handover area, or a trigger condition for handing over the UE from a cell in the non-free handover area to a cell in the free handover area. Optionally, the trigger condition for handing over the UE to a cell in the free handover area may be the same as or different from a trigger condition for measurement reporting in the prior art.

Step 112: The serving base station delivers the cell list and the measurement parameter to the UE, so that the UE performs cell measurement according to the measurement parameter to obtain a measurement result, and when the measurement result includes a cell belonging to the cell list, the UE selects the cell belonging to the cell list from the measurement result to serve as a target cell, and the UE is handed over to the target cell.

In this embodiment, the serving base station may deliver the cell list and the measurement parameter to the UE by using one message; or, the serving base station may also deliver the cell list and the measurement parameter by using different messages.

It can be seen from the foregoing embodiment that, when the UE is handed over to a cell in the free handover area, compared with an existing cell handover, the number of signaling exchanges between the serving base station of the UE and the UE and between the serving base station of the UE and a target base station is decreased, which therefore saves signaling overheads of a system, reduces radio resources occupied by a large number of signaling overheads, and improves efficiency of a cell handover.

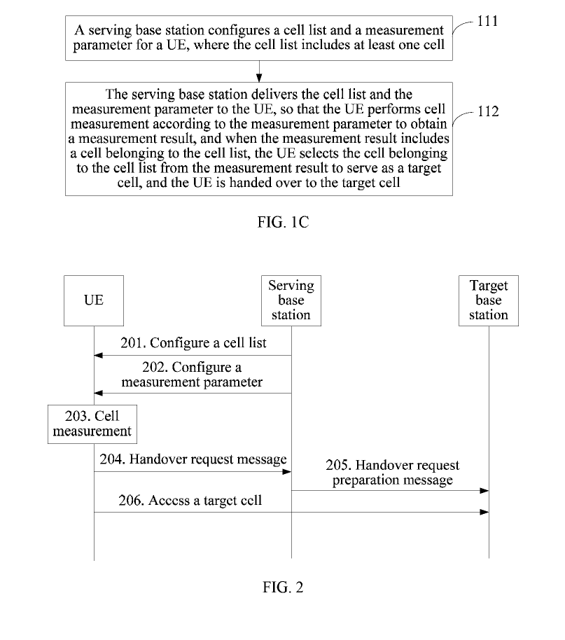

Referring to FIG. 2, FIG. 2 is a flowchart of another embodiment of a cell handover method according to the present invention, and the embodiment describes a cell handover process by means of interactions between a UE, a serving base station and a target base station.

Step 201: A serving base station configures a cell list for a UE, where the cell list includes at least one cell in a free handover area.

The serving base station is a base station that is currently accessed by the UE and provides an uplink and downlink data transmission service for the UE. In this embodiment, the serving base station may be a base station in the free handover area, or a base station in a non-free handover area, and a target base station is a base station in the free handover area. By using that a source base station and the target base station are both base stations in the free handover area as an example, each base station in the free handover area may obtain in advance a correspondence between a base station identity of another base station and a cell identity corresponding to the another base station. For example, a base station 1 corresponds to three cells, namely, a cell 11, a cell 12 and a cell 13, and another base station may obtain a correspondence between the base station 1 and the cell 11, between the base station 1 and the cell 12, and between the base station 1 and the cell 13 in advance by means of interactions between the base stations, and store the correspondence.

In this embodiment, the cell list includes a cell in the free handover area, where the cell may be indicated by using cell identity information, and the cell identity information may specifically be a physical cell identity (PCI), a cell global identity (CGI), or the like. The serving base station may deliver a cell list to all UEs of the serving base station by using a system broadcast message when configuring the cell list for the UEs; and the serving base station may also deliver a cell list to a specific UE by using a radio resource control (RRC) message, or a media access control (MAC) layer message, or a physical layer message when it is required to configure the cell list for the specific UE.

Optionally, when configuring the cell list, the serving base station may configure the cell list according to a preset configuration condition; for example, if the configuration condition is a load threshold of a cell, before configuring the cell list, the serving base station may obtain load information of each cell, determine whether current load of the cell exceeds the load threshold according to the load information, and add a cell whose load does not exceed the load threshold to the cell list.

Optionally, when configuring the cell list, the serving base station may further configure a priority sequence of cells in the cell list, so that the UE selects an eligible target cell according to the cell priority sequence; optionally, when configuring the cell list, the serving base station may further configure a priority sequence of executing a normal handover process or a free handover process, so that when cells in a subsequent measurement result that meet a handover condition include both a cell in the free handover area and a cell in the non-free handover area, a handover in the free handover area may be executed preferentially.

It can be understood that, the serving base station may update the cell list configured for the UE, that is, update information about a cell that is in the free handover area and is included in the cell list, such as increasing, decreasing or modifying a cell, and changing a cell priority sequence.

Step 202: The serving base station configures a measurement parameter for the UE.

The measurement parameter configured by the serving base station for the UE may include a parameter consistent with that in the prior art for the UE to perform the cell measurement, and the parameter may include information such as a measurement object, a measurement item, and a measurement reporting condition.

In this embodiment, the measurement parameter may further include a trigger condition for handing over the UE to a cell in the free handover area, that is, may specifically refer to: the measurement parameter includes a trigger condition for handing over the UE between cells in the free handover area, or a trigger condition for handing over the UE over from a cell in the non-free handover area to a cell in the free handover area, where the trigger condition may refer to a condition that needs to be met by a measurement result when the UE is handed over to a potential target cell.

For example, the trigger condition may be: a measurement result of a measurement item (such as signal strength or signal quality) for a neighboring cell is better than a measurement result of the measurement item for a serving cell; or, a measurement result of a measurement item for a neighboring cell is better than a measurement result of the measurement item for a serving cell, a difference between the measurement results is greater than a certain predetermined threshold value, and correspondingly, the configured trigger condition includes the threshold value; or, a measurement result of a measurement item for a neighboring cell is better than a measurement result of the measurement item for a serving cell, a difference between the measurement results is greater than a certain predetermined threshold value, and in a predetermined duration, the difference between the measurement results is always greater than the predetermined threshold value, and correspondingly, the configured trigger condition includes the threshold value and the duration. Optionally, the trigger condition may further include a load threshold of a neighboring cell. That is, when the measurement result of the measurement item meets the requirement, it is further required that load of the neighboring cell is lower than a predetermined threshold. In the configured specific trigger condition, the set threshold value may be different from that in the prior art, for example, may be greater than an existing threshold value; or, the set duration may be different from that in the prior art, for example, may be longer than an existing duration.

Corresponding to the trigger condition configured by the serving base station, after obtaining measurement results of a serving cell and a neighboring cell, the UE compares the measurement result of the neighboring cell with the measurement result of the serving cell to see whether the foregoing trigger condition is met. For example, when the measurement result of a measurement item for the neighboring cell is better than the measurement result of the measurement item for the serving cell, it may be determined that the trigger condition is met; or, when the measurement result of a measurement item for the neighboring cell is better than the measurement result of the measurement item for the serving cell, and a difference between the measurement results is greater than a certain predetermined threshold value, it may be determined that the trigger condition is met; or, when the measurement result of a measurement item for the neighboring cell is better than the measurement result of the measurement item for the serving cell, a difference between the measurement results is greater than a certain predetermined threshold value, and in a predetermined duration, the difference between the measurement results is always greater than the predetermined threshold value, it is determined that the trigger condition is met. Optionally, when the load threshold of the neighboring cell is configured, the UE further needs to determine whether current load of the neighboring cell is lower than the predetermined load threshold, and if a determination result is that the current load of the neighboring cell is lower than the load threshold, it is determined that the trigger condition is met.

It should be noted that, the foregoing is only an exemplary description of the trigger condition, and the trigger condition may be set flexibly as required in an actual application, which is not limited in the embodiment of the present invention.

Step 203: The UE performs cell measurement according to the measurement parameter to obtain a measurement result, and selects a cell belonging to the cell list from the measurement result to serve as a target cell.

In this embodiment, the UE performs cell measurement according to a measurement object and a measurement item that are included in the measurement parameter, so as to obtain the measurement result. A specific measurement process is consistent with that in the prior art, and is not described herein again. In this embodiment, potential target cells of the UE may include a cell in the free handover area, and may also include a cell in the non-free handover area.

After completing measurement of multiple potential target cells, when the measurement result includes one cell that belongs to the cell list, the UE uses the cell as the target cell, and when the measurement result includes multiple cells that belong to the cell list, the UE may select a cell having a best measurement result from the multiple cells to serve as the target cell of the UE, or select, according to a cell priority configured by the base station, a cell with a highest priority from the multiple cells to serve as the target cell of the UE.

Optionally, when the measurement parameter further includes the trigger condition, the UE may: select a cell meeting the trigger condition and belonging to the cell list from the measurement result; when the selected cell includes one cell, use the cell as the target cell of the UE, and when the selected cell includes multiple cells, select a cell having a best measurement result from the multiple cells to serve as the target cell of the UE, or select a cell with a highest priority from the multiple cells to serve as the target cell of the UE. Specifically, the UE may: compare a measurement result of each cell with the trigger condition, obtain a first cell set formed by the cell that corresponds to the measurement result meeting the trigger condition, obtain a cell identity belonging to the cell list from a cell identity of the first cell set, and form a second cell set by using a cell that corresponds to the cell identity belonging to the cell list; when the second cell set includes one cell, use the cell as the target cell of the UE, or when the second cell set includes multiple cells, select a cell having a best measurement result from the multiple cells to serve as the target cell of the UE, or select, according to a cell priority configured by the base station, a cell with a highest priority from the multiple cells to serve as the target cell of the UE. Alternatively, the UE may also first determine whether each cell in the measurement result belongs to the cell list, form a second cell set by using a cell belonging to the cell list, compare each cell in the second cell set with the trigger condition, obtain a first cell set formed by a cell meeting the trigger condition; when the first cell set includes one cell, use the cell as the target cell of the UE, and when the first cell set includes multiple cells, select a cell having a best measurement result from the multiple cells to serve as the target cell of the UE, or select, according to a cell priority configured by the base station, a cell with a highest priority from the multiple cells to serve as the target cell of the UE.

For example, a cell 1, a cell 2, and a cell 3 are cells in the free handover area, a cell A, a cell B, and a cell C are cells in the non-free handover area, and measurement parameters configured by the serving base station for the two types of cells may be the same or different. Assume that the current serving cell is the cell 3 of the serving base station. Obtained potential target cells meeting the trigger condition may have the following situations: (1) the potential target cells meeting the trigger condition include both a cell in the free handover area and a cell in the non-free handover area, or (2) the potential target cells meeting the trigger condition are all the cells in the free handover area, or (3) the potential target cells meeting the trigger condition are all the cells in the non-free handover area. As for the foregoing situation (1), the UE may select the cell in the free handover area to serve as the target cell; as for the forgoing situation (2), the UE may directly select the target cell from the cells in the free handover area; and as for the foregoing situation (3), the UE may execute an existing cell handover method.

Step 204: The UE sends a handover request message to the serving base station, where the handover request message includes a cell identity of the target cell.

In this embodiment, the UE obtains the target cell belonging to the cell list according to the measurement result, and then the UE sends the handover request message including the cell identity of the target cell to the serving base station. The handover request message may specifically be an RRC message, a MAC layer message, or a physical layer message.

Optionally, in step 204, the UE may also send only a measurement report message including the measurement result to the serving base station, where the measurement report message may include a measurement result of a cell meeting the trigger condition and belonging to the cell list, and after receiving the measurement report message, the serving base station selects a cell having a best measurement result from multiple cells in the measurement report message to serve as the target cell of the UE, or selects, according to a cell priority configured by the base station, a cell with a highest priority from the multiple cells to serve as the target cell of the UE.

Step 205: The serving base station sends a handover request preparation message to a target base station to which the target cell belongs.

In this step, after the serving base station obtains the target cell of the UE by using whether the handover request message sent by the UE or the measurement report message sent by the UE, the serving base station may obtain a base station to which the target cell belongs according to a stored correspondence between a base station and a cell, use the base station as the target base station of the UE, and send the handover request preparation message to the target base station.

In this embodiment, the handover request preparation message includes context information of the UE, where the context information may include an identity of the UE, information about a radio bearer (RB) set up by the UE, an identity of the target cell, and the like.

Optionally, the target base station may also return a handover request response message to the serving base station after receiving the handover request preparation message sent by the serving base station; optionally, the serving base station may also stop scheduling uplink and downlink data of the UE after receiving the handover request message sent by the UE.

Optionally, before receiving the handover request message sent by the UE, the serving base station may send the handover request preparation message to one or more base stations to which the potential target cells belong, so that the potential target cells prepare for a cell handover of the UE. The handover request preparation message may specifically be an X2 interface (an interface between base stations) message, or an S1 interface (an interface between a base station and a core network entity) message. Based on this, as can be understood, it is equivalent to that the context information of the UE has been stored in multiple base stations in advance, and when the UE executes the handover, the context information of the UE does not need to be transferred again, thereby reducing the transfer frequency of the context information, and reducing signaling overheads. Further, after the context information of the UE is changed (for example, the UE sets up a new radio bearer, releases a radio bearer, or changes a radio bearer), the serving base station may send the handover request preparation message again to the one or more base stations to which the potential target cells belong, so that the base stations update the context information of the UE. It can be known that, by sending the handover request preparation message in advance, the handover process may be accelerated, and the handover delay may be decreased.

It should be noted that, in this step, the serving base station and the target base station refer to different base stations, and when the serving base station and the target base station are a same base station, this step may be omitted.

Step 206: The UE is handed over to the target cell of the target base station.

In this embodiment, the UE may access the target cell of the target base station after sending the handover request message; or, the UE may also access the target cell of the target base station after receiving a hybrid automatic repeat request (HARQ) acknowledgement (ACK) sent by the serving base station; or, the UE may also access the target cell of the target base station after receiving an ACK message from a radio link control (RLC) layer of the serving base station; or, the UE may also access the target cell of the target base station after receiving an ACK message from an RRC layer of the serving base station.

In this embodiment, when the UE is handed over to the target cell, a handover manner in the prior art may be used, where the UE and the target base station, where the target cell is located, perform downlink synchronization and uplink synchronization respectively, and after receiving an uplink resource allocated by the target base station, the UE sends a handover complete message to the target base station, thereby completing a handover to the target cell.

In this embodiment, in addition to using the handover manner in the prior art, this embodiment may further use the following possible manners to perform a handover to the target cell:

First access manner The UE accesses the target cell of the target base station in a random access manner.

The UE may select a preamble from an available preamble set in the process of executing contention-based random access, or use a dedicated preamble in the process of executing a non-contention-based random access, and send a random access request to the target base station by using an available PRACH resource;

the target base station sends a random access response (RAR) message to the UE, where the RAR message includes uplink grant information, and the uplink grant information includes information required by the UE for uplink transmission, such as a physical resource and a modulation and coding scheme;

the UE sends an uplink message to the target base station according to the uplink grant information. As for the contention-based random access process, the uplink message includes at least an identity of the UE, and may further include an identity of a serving cell of the serving base station; as for the non-contention-based random access process, the uplink message may include the identity of the UE, and may further include the identity of the serving cell of the serving base station. The uplink message may specifically be borne by a MAC CE (control element), or an RRC layer message, or a combination of a MAC CE and an RRC layer message;

as for the contention-based random access process, the target base station sends a contention resolution message to the UE after receiving the uplink message, and after the UE receives the contention resolution message, the UE confirms that the random access process is completed, the UE accesses the target base station successfully, and at this time, the target base station becomes a new serving base station of the UE; as for the non-contention-based random access process, after successfully receiving the RAR message or completing sending the uplink message, the UE confirms that the random access process is completed, the UE accesses the target base station successfully, and at this time, the target base station becomes a new serving base station of the UE.

In the foregoing first access manner, the preamble set and the physical random access channel (PRACH) resource of the target base station may be notified by the serving base station to the UE in advance, and may also be obtained by the UE from a system broadcast message of the target base station when the UE accesses the target base station.

Optionally, the preamble set and the PRACH resource of the target base station may be the same as those of the serving base station by default, and in this case, the serving base station may not need to notify the UE of the preamble set and the PRACH resource of the target base station, or the UE does not need to obtain the preamble set and the PRACH resource by reading the system broadcast message of the target base station either. This manner may further reduce signaling overheads in the system, and decrease the delay of the UE in accessing the target cell.

Optionally, the serving base station may allocate a dedicated preamble and a dedicated PRACH resource to the UE, and the UE accesses the target cell by using the dedicated preamble and the dedicated PRACH resource.

Second access manner The UE directly accesses the target cell of the target base station.

Because the serving base station has sent the context information of the UE to the target base station, the target base station can acquire, according to the context information of the UE, that the UE enters the target base station, and the UE can listen on a physical downlink control channel (PDCCH) of the target base station to obtain control signaling sent by the base station through the PDCCH.

Third access manner The UE accesses the target cell of the target base station by sending an SR.

The third access manner may aim at a case where the target cell is a small cell, and in this case, the UE may send a scheduling request (SR) to the target base station directly according to a specific timing advance (TA), so as to access the target base station, where the specific TA may be 0, or a TA the same as a TA being used in the current serving base station, or a TA value notified by the serving base station to the UE.

The foregoing SR is notified by the serving base station to the UE, the serving base station may also notify the target base station of the SR allocated to the UE when notifying the target base station of the context information of the UE, and after the target base station receives the SR, the target base station can acquire that the UE accesses the target base station, so as to allocate an uplink resource or a downlink resource for data transmission to the UE; at this time, the target base station becomes a new serving base station of the UE. It should be noted that, the foregoing SR may be replaced with another resource, such as a sounding reference signal (SRS), which is not limited in the embodiment of the present invention.

Fourth access manner In conjunction with the foregoing random access manner or the manner of sending an SR, the UE accesses the target cell by sending a Layer 2 (such as a MAC message) or a Layer 3 (such as an RRC message) message to the target cell.

It can be seen from the foregoing embodiment that, when the UE is handed over to a cell in the free handover area, compared with an existing cell handover, the number of signaling exchanges between the serving base station of the UE and the UE and between the serving base station of the UE and a target base station is decreased, which therefore saves signaling overheads of a system, reduces radio resources occupied by a large number of signaling overheads, and improves efficiency of a cell handover.

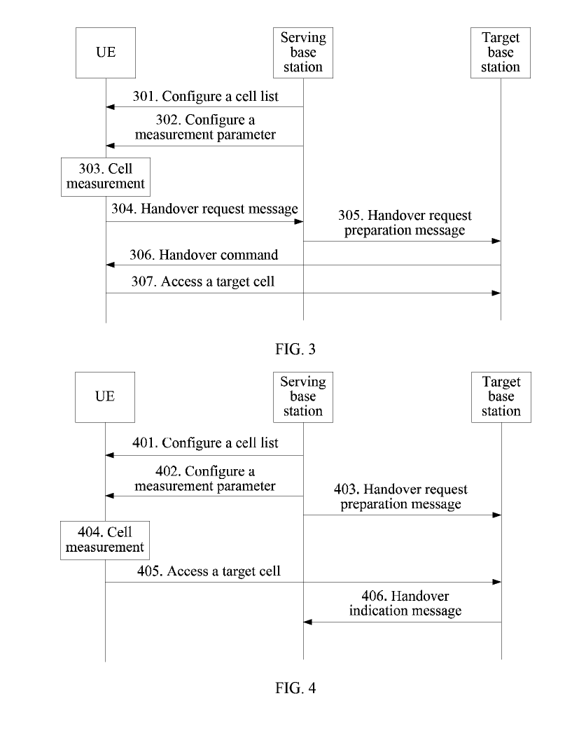

Referring to FIG. 3, FIG. 3 is a flowchart of another embodiment of a cell handover method according to the present invention, and the embodiment describes a cell handover process by means of interactions between a UE, a serving base station, and a target base station.

Step 301: A serving base station configures a cell list for a UE, where the cell list includes at least one cell in a free handover area.

The serving base station is a base station that is currently accessed by the UE and provides an uplink and downlink data transmission service for the UE. In this embodiment, the serving base station may be a base station in the free handover area, or a base station in a non-free handover area, and a target base station is a base station in the free handover area. By using that a source base station and the target base station are both base stations in the free handover area as an example, each base station in the free handover area may obtain in advance a correspondence between a base station identity of another base station and a cell identity corresponding to the another base station. For example, a base station 1 corresponds to three cells, namely, a cell 11, a cell 12, and a cell 13, and another base station may obtain a correspondence between the base station 1 and the cell 11, between the base station 1 and the cell 12, and between the base station 1 and the cell 13 in advance by means of interactions between the base stations, and store the correspondence.

In this embodiment, the cell list includes a cell in the free handover area, and the cell may be distinguished by using cell identity information, where the cell identity information may specifically be a PCI, a CGI, or the like. The serving base station may deliver a cell list to all UEs of the serving base station by using a system broadcast message when configuring the cell list for the UEs; and the serving base station may also deliver a cell list to a specific UE by using an RRC message, or a MAC layer message, or a physical layer message when it is required to configure the cell list for the specific UE.

Optionally, when configuring the cell list, the serving base station may configure the cell list according to a preset configuration condition. For example, if the configuration condition is a load threshold of a cell, before configuring the cell list, the serving base station may obtain load information of each cell, determine whether current load of the cell exceeds the load threshold according to the load information, and add a cell whose load does not exceed the load threshold to the cell list.

Optionally, when configuring the cell list, the serving base station may further configure a priority sequence of cells in the cell list, so that the UE selects an eligible target cell according to a cell priority sequence; optionally, when configuring the cell list, the serving base station may further configure a priority sequence of executing a normal handover process or a free handover process, so that when cells in a subsequent measurement result that meet a handover condition include both a cell in the free handover area and a cell in the non-free handover area, a handover in the free handover area may be executed preferentially.

It can be understood that, the serving base station may update the cell list configured for the UE, that is, update information about a cell that is in the free handover area and is included in the cell list, such as increasing, decreasing or modifying a cell, and changing a cell priority sequence.

Step 302: The serving base station configures a measurement parameter for the UE.

The measurement parameter configured by the serving base station for the UE may include a parameter consistent with that in the prior art for the UE to perform the cell measurement, and the parameter may include information such as a measurement object, a measurement item, and a measurement reporting condition.

In this embodiment, the measurement parameter may further include a trigger condition for handing over the UE to a cell in the free handover area, that is, may specifically refer to: the measurement parameter includes a trigger condition for handing over the UE between cells in the free handover area, or a trigger condition for handing over the UE over from a cell in the non-free handover area to a cell in the free handover area, where the trigger condition may refer to a condition that needs to be met by a measurement result when the UE is handed over to a potential target cell. In this embodiment, potential target cells of the UE may include a cell in the free handover area, and may also include a cell in the non-free handover area. In this embodiment, as for the detailed description of the trigger condition, reference may be made to the description of the embodiment in FIG. 2, which is not described herein again.

Step 303: The UE performs cell measurement according to the measurement parameter to obtain a measurement result, and selects a cell belonging to the cell list from the measurement result to serve as a target cell.

In this embodiment, the UE performs cell measurement according to a measurement object and a measurement item that are included in the measurement parameter, so as to obtain the measurement result. A specific measurement process is consistent with that in the prior art, and is not described herein again. In this embodiment, potential target cells of the UE may include a cell in the free handover area, and may also include a cell in the non-free handover area.

After completing measurement of multiple potential target cells, when the measurement result includes one cell that belongs to the cell list, the UE uses the cell as the target cell, and when the measurement result includes multiple cells that belong to the cell list, the UE may select a cell having a best measurement result from the multiple cells to serve as the target cell of the UE, or select, according to a cell priority configured by the base station, a cell with a highest priority from the multiple cells to serve as the target cell of the UE.

Optionally, when the measurement parameter further includes the trigger condition, the UE may: select a cell meeting the trigger condition and belonging to the cell list from the measurement result; when the selected cell includes one cell, use the cell as the target cell of the UE, and when the selected cell includes multiple cells, select a cell having a best measurement result from the multiple cells to serve as the target cell of the UE, or select a cell with a highest priority from the multiple cells to serve as the target cell of the UE.

Step 304: The UE sends a handover request message to the serving base station, where the handover request message includes a cell identity of the target cell.

In this embodiment, the UE obtains the target cell belonging to the cell list according to the measurement result, and then the UE sends the handover request message including the cell identity of the target cell to the serving base station. The handover request message may specifically be an RRC message, a MAC layer message, or a physical layer message.

Optionally, in step 304, the UE may also send only a measurement report message including the measurement result to the serving base station, where the measurement report message may include a measurement result of a cell meeting the trigger condition and belonging to the cell list, and after receiving the measurement report message, the serving base station selects a cell having a best measurement result from multiple cells in the measurement report message to serve as the target cell of the UE, or selects, according to a cell priority configured by the base station, a cell with a highest priority from multiple cells to serve as the target cell of the UE.

Step 305: The serving base station sends a handover request preparation message to a target base station to which the target cell belongs.

In this step, after the serving base station obtains the target cell of the UE by using whether the handover request message sent by the UE or the measurement report message sent by the UE, the serving base station may obtain a base station to which the target cell belongs according to a stored correspondence between a base station and a cell, use the base station as the target base station of the UE, and send the handover request preparation message to the target base station.

In this embodiment, the handover request preparation message includes context information of the UE, where the context information may include an identity of the UE, information about an RB set up by the UE, an identity of the target cell, and the like.

Optionally, the target base station may also return a handover request response message to the serving base station after receiving the handover request preparation message sent by the serving base station; optionally, the serving base station may also stop scheduling uplink and downlink data of the UE after receiving the handover request message sent by the UE.

It should be noted that, in this step, the serving base station and the target base station refer to different base stations, and when the serving base station and the target base station are a same base station, this step may be omitted.

Step 306: The UE receives a handover command generated by the target base station according to the handover request preparation message.

A main difference between this embodiment and the embodiment shown in FIG. 2 lies in that, the UE accesses the target base station according to triggering by the handover command sent by the target base station.

Step 307: The UE is handed over to the target cell according to the triggering by the handover command

Optionally, the target base station may schedule the handover command by using a cell radio network temporary identity (C-RNTI) allocated by the serving base station to the UE.

The C-RNTIs used by the UE at the target base station and the serving base station may be the same, and may also be different. When the C-RNTIs are the same, the UE may receive the handover command directly according to a manner of receiving a scheduling command and data at the target base station, for example, using a cell-level scrambling code of the target base station to receive the handover command; or it is preset that the UE receives a scheduling command and data from the serving base station and the target base station in a same manner, or it is preset that the UE receives a scheduling command and data from each cell in the free handover area in a same manner. When the C-RNTIs are different, the UE may receive the handover command according to a manner of receiving a scheduling command and data from the serving base station, and then, according to the C-RNTI in the handover command, performs subsequent receiving according to a manner of receiving a scheduling command and data from the target base station. Optionally, the handover command may be masked by using a cell identity of a source cell, or may be masked by using a cell identity of the target cell.

Optionally, before the target base station sends the handover command, the UE may be instructed to execute the random access process, so as to achieve uplink synchronization between the UE and the target base station.

It can be seen from the foregoing embodiment that, when the UE is handed over to a cell in the free handover area, compared with an existing cell handover, the number of signaling exchanges between the serving base station of the UE and the UE and between the serving base station of the UE and a target base station is decreased, which therefore saves signaling overheads of a system, reduces radio resources occupied by a large number of signaling overheads, and improves efficiency of a cell handover.

Referring to FIG. 4, FIG. 4 is a flowchart of another embodiment of a cell handover method according to the present invention, and the embodiment describes a cell handover process by means of interactions between a UE, a serving base station, and a target base station.

Step 401: A serving base station configures a cell list for a UE, where the cell list includes at least one cell in a free handover area.

The serving base station is a base station that is currently accessed by the UE and provides an uplink and downlink data transmission service for the UE. In this embodiment, the serving base station may be a base station in the free handover area, or a base station in a non-free handover area, and a target base station is a base station in the free handover area. By using that a source base station and the target base station are both base stations in the free handover area as an example, each base station in the free handover area may obtain in advance a correspondence between a base station identity of another base station and a cell identity corresponding to the another base station. For example, a base station 1 corresponds to three cells, namely, a cell 11, a cell 12, and a cell 13, and another base station may obtain a correspondence between the base station 1 and the cell 11, between the base station 1 and the cell 12, and between the base station 1 and the cell 13 in advance by means of interactions between the base stations, and store the correspondence.

In this embodiment, the cell list includes a cell in the free handover area, and the cell may be indicated by using cell identity information, where the cell identity information may specifically be a PCI, a CGI, or the like. The serving base station may deliver a cell list to all UEs of the serving base station by using a system broadcast message when configuring the cell list for the UEs; and the serving base station may also deliver a cell list to a specific UE by using an RRC message, or a MAC layer message, or a physical layer message when it is required to configure the cell list for specific UE.

Optionally, when configuring the cell list, the serving base station may configure the cell list according to a preset configuration condition. For example, if the configuration condition is a load threshold of a cell, before configuring the cell list, the serving base station may obtain load information of each cell, determine whether current load of the cell exceeds the load threshold according to the load information, and add a cell whose load does not exceed the load threshold to the cell list.

Optionally, when configuring the cell list, the serving base station may further configure a priority sequence of cells in the cell list, so that the UE selects an eligible target cell according to a cell priority sequence; optionally, when configuring the cell list, the serving base station may further configure a priority sequence of executing a normal handover process or a free handover process, so that when cells in a subsequent measurement result that meet a handover condition include both a cell in the free handover area and a cell in the non-free handover area, a handover in the free handover area may be executed preferentially.

It can be understood that, the serving base station may update the cell list configured for the UE, that is, update information about a cell that is in the free handover area and is included in the cell list, such as increasing, decreasing or modifying a cell, and changing a cell priority sequence.

Step 402: The serving base station configures a measurement parameter for the UE.

The measurement parameter configured by the serving base station for the UE may include a parameter consistent with that in the prior art for the UE to perform the cell measurement, and the parameter may include information such as a measurement object, a measurement item, and a measurement reporting condition.

In this embodiment, the measurement parameter may further include a trigger condition for handing over the UE to a cell in the free handover area, that is, may specifically refer to: the measurement parameter includes a trigger condition for handing over the UE between cells in the free handover area, or a trigger condition for handing over the UE from a cell in the non-free handover area to a cell in the free handover area, where the trigger condition may refer to a condition that needs to be met by a measurement result when the UE is handed over to a potential target cell. In this embodiment, potential target cells of the UE may include a cell in the free handover area, and may also include a cell in the non-free handover area. In this embodiment, as for the detailed description of the trigger condition, reference may be made to the description of the embodiment in FIG. 2, which is not described herein again.

Step 403: The serving base station sends a handover request preparation message to a base station to which a cell in the cell list belongs.

A difference between this embodiment and the embodiments shown in FIG. 2 and FIG. 3 lies in that, the serving base station regards all cells in the cell list as potential target cells of the UE, sends the handover request preparation message to one or more base stations to which the potential target cells belong, so that the potential target cells prepare for a cell handover of the UE. The handover request preparation message may specifically be an X2 interface (an interface between base stations) message, or an S1 interface (an interface between a base station and a core network entity) message. Based on this, as can be understood, it is equivalent to that context information of the UE has been stored in multiple base stations in advance, and when the UE executes the handover, the context information of the UE does not need to be transferred again, thereby reducing the transfer frequency of the context information, and reducing signaling overheads. Further, after the context information of the UE is changed (for example, the UE sets up a new radio bearer, releases a radio bearer, or changes a radio bearer), the serving base station may send the handover request preparation message again to the one or more base stations to which the potential target cells belong, so that the base stations update the context information of the UE. It can be known that, by sending the handover request preparation message in advance, the handover process may be accelerated, and the handover delay may be decreased.

Step 404: The UE performs cell measurement according to the measurement parameter to obtain a measurement result, and selects a cell belonging to the cell list from the measurement result to serve as a target cell.

In this embodiment, the UE performs cell measurement according to a measurement object and a measurement item that are included in the measurement parameter, so as to obtain the measurement result. A specific measurement process is consistent with that in the prior art, and is not described herein again. In this embodiment, potential target cells of the UE may include a cell in the free handover area, and may also include a cell in the non-free handover area.

After completing measurement of multiple potential target cells, when the measurement result includes one cell that belongs to the cell list, the UE uses the cell as the target cell, and when the measurement result includes multiple cells that belong to the cell list, the UE may select a cell having a best measurement result from the multiple cells to serve as the target cell of the UE, or select, according to a cell priority configured by the base station, a cell with a highest priority from the multiple cells to serve as the target cell of the UE.

Optionally, when the measurement parameter further includes the trigger condition, the UE may: select a cell meeting the trigger condition and belonging to the cell list from the measurement result; when the selected cell includes one cell, use the cell as the target cell of the UE, and when the selected cell includes multiple cells, select a cell having a best measurement result from the multiple cells to serve as the target cell of the UE, or select a cell with a highest priority from the multiple cells to serve as the target cell of the UE.

Step 405: The UE is handed over to the target cell of the target base station.

In this embodiment, the UE may access the target cell after selecting the target cell; or, the UE may also access the target cell of the target base station after receiving an HARQ ACK sent by the serving base station; or, the UE may also access the target cell of the target base station after receiving an ACK message from an RLC layer of the serving base station; or, the UE may also access the target cell of the target base station after receiving an ACK message from an RRC layer of the serving base station.

In this embodiment, when the UE is handed over to the target cell, a handover manner in the prior art may be used, where the UE and the target base station, where the target cell is located, perform downlink synchronization and uplink synchronization respectively, and after receiving an uplink resource allocated by the target base station, the UE sends a handover complete message to the target base station, thereby completing a handover to the target cell. In addition to the handover manner in the prior art, in this embodiment, the UE may also be handed over to the target cell in a random access manner, or may also be directly handed over to the target cell, or may also be handed over to the target cell by sending a scheduling request (SR), or in conjunction with the random access manner or the manner of sending an SR, may be handed over to the target cell by sending a Layer 2 message (such as a MAC message) or a Layer 3 message (such as an RRC message) to the target cell. As for detailed descriptions of the foregoing manners, reference may be made to step 206 in FIG. 2, which is not described herein again.

Step 406: The target base station sends a handover indication message to the serving base station, so as to indicate that the UE has accessed the target base station.

After the UE accesses the target cell, the target base station to which the target cell belongs sends the handover indication message to the serving base station, and at this time, the target base station becomes a new serving base station of the UE.

It can be seen from the foregoing embodiment that, when the UE is handed over to a cell in the free handover area, compared with an existing cell handover, the number of signaling exchanges between the serving base station of the UE and the UE and between the serving base station of the UE and a target base station is decreased, which therefore saves signaling overheads of a system, reduces radio resources occupied by a large number of signaling overheads, and improves efficiency of a cell handover.

Corresponding to the embodiments of the cell handover method according to the present invention, the present invention further provides embodiments of a UE and a base station for executing a cell handover.

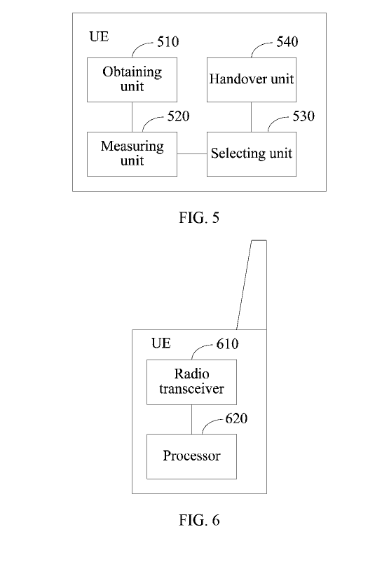

Referring to FIG. 5, FIG. 5 is a block diagram of an embodiment of a UE according to the present invention.

The UE includes: an obtaining unit 510, a measuring unit 520, a selecting unit 530, and a handover unit 540.

The obtaining unit 510 is configured to obtain a cell list and a measurement parameter that are configured by a serving base station, where the cell list includes at least one cell.

The measuring unit 520 is configured to perform cell measurement according to the measurement parameter to obtain a measurement result.

The selecting unit 530 is configured to: when the measurement result includes a cell belonging to the cell list, select the cell belonging to the cell list from the measurement result to serve as a target cell.

The handover unit 540 is configured to hand over the UE to the target cell.

Optionally, the UE may further include a sending unit, configured to: send a handover request message to the serving base station, where the handover request message includes a cell identity of the target cell, so that the serving base station sends, according to the cell identity, a handover request preparation message to a target base station to which the target cell belongs; or, send a measurement report message to the serving base station, where the measurement report message includes a measurement result of a cell belonging to the cell list, so that the serving base station selects from the measurement result a cell having a best measurement result to serve as the target cell of the UE, or selects from the measurement result a cell with a highest priority to serve as the target cell of the UE, and sends a handover request preparation message to a target base station to which the target cell belongs.

Optionally, the UE may further include a receiving unit, configured to receive a handover command generated by the target base station according to the handover request preparation message, where the handover unit is specifically configured to access the target cell after the handover command is received, or access the target cell after the handover command is received and a handover complete message is sent to the target cell.

Optionally, the obtaining unit 510 is specifically configured to: obtain, from one message delivered by the serving base station, the cell list and the measurement parameter that are configured by the serving base station; or obtain, from different messages delivered by the serving base station, the cell list and the measurement parameter that are configured by the serving base station.

Optionally, the selecting unit 530 may include: a first selecting subunit, configured to select a cell meeting a trigger condition and belonging to the cell list from the measurement result; and a second selecting subunit, configured to: when the cell selected by the first selecting subunit includes one cell, use the cell as the target cell of the UE, and when the cell selected by the first selecting subunit includes multiple cells, select one cell having a best measurement result from the multiple cells to serve as the target cell of the UE, or select one cell with a highest priority from the multiple cells to serve as the target cell of the UE.

Optionally, the handover unit 540 may include at least one of the following subunits: a first handover subunit, configured to perform a handover to the target cell in a random access manner; a second handover subunit, configured to directly perform a handover to the target cell; a third handover subunit, configured to perform a handover to the target cell by sending a scheduling request SR; and a fourth handover subunit, configured to perform a handover to the target cell by sending a Layer 2 message or a Layer 3 message to the target cell.

Referring to FIG. 6, FIG. 6 is a block diagram of another embodiment of a UE according to the present invention.

The UE includes: a radio transceiver 610 and a processor 620.

The radio transceiver 610 is configured to obtain a cell list and a measurement parameter that are configured by a serving base station, where the cell list includes at least one cell.

The processor 620 is configured to: perform cell measurement according to the measurement parameter to obtain a measurement result, and when the measurement result includes a cell belonging to the cell list, select the cell belonging to the cell list from the measurement result to serve as a target cell, and hand over the UE to the target cell.

Optionally, the radio transceiver 610 may further be configured to: send a handover request message to the serving base station, where the handover request message includes a cell identity of the target cell, so that the serving base station sends, according to the cell identity, a handover request preparation message to a target base station to which the target cell belongs; or, send a measurement report message to the serving base station, where the measurement report message includes a measurement result of a cell belonging to the cell list, so that the serving base station selects from the measurement result a cell having a best measurement result to serve as the target cell of the UE, or selects from the measurement result a cell with a highest priority to serve as the target cell of the UE, and sends a handover request preparation message to a target base station to which the target cell belongs.

Optionally, the radio transceiver 610 may be further configured to receive a handover command generated by the target base station according to the handover request preparation message; and the processor 620 may be specifically configured to access the target cell after the handover command is received, or access the target cell after the handover command is received and a handover complete message is sent to the target cell.

Optionally, the radio transceiver 610 may be specifically configured to: obtain, from one message delivered by the serving base station, the cell list and the measurement parameter that are configured by the serving base station; or obtain, from different messages delivered by the serving base station, the cell list and the measurement parameter that are configured by the serving base station.

Optionally, the processor 620 may be specifically configured to: select a cell meeting a trigger condition and belonging to the cell list from the measurement result; when the selected cell includes one cell, use the cell as the target cell of the UE, and when the selected cell includes multiple cells, select one cell having a best measurement result from the multiple cells to serve as the target cell of the UE, or select one cell with a highest priority from the multiple cells to serve as the target cell of the UE.

Optionally, the processor may perform a handover to the target cell by using at least one of the following manners: the processor performs a handover to the target cell in a random access manner; the processor directly performs a handover to the target cell; the processor performs a handover to the target cell by sending a scheduling request SR; and the processor performs a handover to the target cell by sending a Layer 2 message or a Layer 3 message to the target cell.

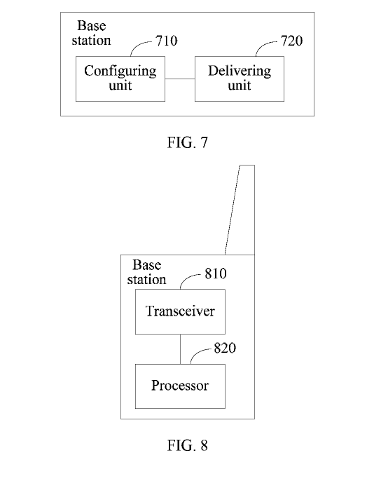

Referring to FIG. 7, FIG. 7 is a block diagram of an embodiment of a base station according to the present invention.

The base station includes: a configuring unit 710 and a delivering unit 720.

The configuring unit 710 is adapted to configure a cell list and a measurement parameter for a UE, where the cell list includes at least one cell.

The delivering unit 720 is configured to deliver the cell list and the measurement parameter to the UE, so that the UE performs cell measurement according to the measurement parameter to obtain a measurement result, and when the measurement result includes a cell belonging to the cell list, the UE selects the cell belonging to the cell list from the measurement result to serve as a target cell, and the UE is handed over to the target cell.

Optionally, the base station may further include: a first receiving unit, configured to receive a handover request message sent by the UE, where the handover request message is a message sent by the UE to the serving base station after the target cell is obtained, and the handover request message includes a cell identity of the target cell; and a first sending unit, configured to send, according to the cell identity of the target cell, a handover request preparation message to a target base station to which the target cell belongs.

Optionally, the base station may further include: a second receiving unit, configured to receive a measurement report message sent by the UE, where the measurement report message includes a measurement result of a cell belonging to the cell list; a selecting unit, configured to select from the measurement result a cell having a best measurement result to serve as the target cell of the UE, or select a cell with a highest priority from the measurement result to serve as the target cell of the UE; and a second sending unit, configured to send a handover request preparation message to a target base station to which the target cell belongs.

Optionally, the base station may further include: a third sending unit, configured to send a handover request preparation message to a base station to which the cell in the cell list belongs; and a third receiving unit, configured to receive a handover indication message, which is sent by a target base station to which the target cell belongs, after the handover request preparation message is received, where the handover indication message is used to indicate that the UE has accessed the target cell.

Optionally, the configuring unit 710 may include: a load information obtaining subunit, configured to obtain load information of each cell; a load threshold determining subunit, configured to determine whether load of each cell exceeds a set load threshold according to the load information; and a cell list configuring subunit, configured to add, according to a determination result, a cell whose load does not exceed the load threshold to the cell list.

Referring to FIG. 8, FIG. 8 is a block diagram of another embodiment of a base station according to the present invention.

The base station includes: a transceiver 810 and a processor 820.

The processor 820, is configured to configure a cell list and a measurement parameter for a UE, where the cell list includes at least one cell.

The transceiver 810 is configured to deliver the cell list and the measurement parameter to the UE, so that the UE performs cell measurement according to the measurement parameter to obtain a measurement result, and when the measurement result includes a cell belonging to the cell list, the UE selects the cell belonging to the cell list from the measurement result to serve as a target cell, and the UE is handed over to the target cell.

Optionally, the transceiver 810 may further be configured to: receive a handover request message sent by the UE, where the handover request message is a message sent by the UE to a serving base station after the target cell is obtained, and the handover request message includes a cell identity of the target cell; and send, according to the cell identity of the target cell, a handover request preparation message to a target base station to which the target cell belongs.

Optionally, the transceiver 810 may further be configured to receive a measurement report message sent by the UE, where the measurement report message includes a measurement result of a cell belonging to the cell list; the processor 820 may further be configured to select from the measurement result a cell having a best measurement result to serve as the target cell of the UE, or select from the measurement result a cell with a highest priority to serve as the target cell of the UE; and the transceiver 810 may further be configured to send a handover request preparation message to a target base station to which the target cell belongs.

Optionally, the transceiver 810 may further be configured to send a handover request preparation message to a base station to which the cell in the cell list belongs, and receive a handover indication message, which is sent by a target base station to which the target cell belongs after the handover request preparation message is received, where the handover indication message is used to indicate that the UE has accessed the target cell.

Optionally, the processor 820 may be specifically configured to obtain load information of each cell, determine whether load of each cell exceeds a set load threshold according to the load information, and add, according to a determination result, a cell whose load does not exceed the load threshold to the cell list.

It can be seen from the foregoing embodiment that, the UE obtains the cell list and the measurement parameter that are configured by the serving base station, where the cell list includes at least one cell; the UE performs cell measurement according to the measurement parameter to obtain a measurement result; when the measurement result includes a cell belonging to the cell list, the UE selects the cell belonging to the cell list from the measurement result to serve as a target cell; and the UE is handed over to the target cell. In the embodiments of the present invention, when the UE is handed over to a cell in a free handover area, the number of signaling exchanges between the serving base station of the UE and the UE and between the serving base station of the UE and a target base station is decreased compared with an existing cell handover, which therefore saves signaling overheads of a system, reduces radio resources occupied by a large number of signaling overheads, and improves efficiency of a cell handover.

A person skilled in the art may clearly understand that technologies in the embodiments of the present invention may be implemented by software in addition to a necessary universal hardware platform. Based on such an understanding, the technical solutions in the embodiments of the present invention essentially, or the part contributing to the prior art may be implemented in the form of a software product. The software product may be stored in a storage medium, such as a ROM/RAM, a magnetic disk, or an optical disc, and include several instructions for instructing a computer device (which may be a personal computer, a server, or a network device) to perform the methods described in the embodiments of the present invention or in some parts of the embodiments.

The embodiments in this specification are described in a progressive manner, same or similar parts in the embodiments may be referred to by each other, and each embodiment focuses on a difference between the embodiment and other embodiments. Especially, a system embodiment is described more simply because the system embodiment is basically similar to a method embodiment; for related descriptions, refer to partial descriptions in the method embodiment.

The foregoing implementation manners of the present invention are not intended to limit the protection scope of the present invention. Any modification, equivalent replacement, and improvement made without departing from the spirit and principle of the present invention shall fall within the protection scope of the present invention.

1. A cell handover method, comprising:
obtaining, by a user equipment (UE), a cell list configured by a serving base station, wherein the cell list comprises at least one cell;
performing, by the UE, a cell measurement corresponding to a cell belonging to the cell list to obtain a measurement result;
by the UE, a cell belonging to the cell list to serve as a target cell based on the measurement result and based on the selected cell being a cell that belongs to the cell list; and
participating, by the UE, in a handover of the UE to the target cell.

2. The method according to claim 1, wherein before the handover, the method further comprises:
sending, by the UE, a handover request message to the serving base station, wherein the handover request message comprises a cell identity of the target cell, so as to enable the serving base station to to send, according to the cell identity, a handover request preparation message to a target base station corresponding to the target cell.

3. The method according to claim 2, wherein participating in the handover further comprises:
receiving, by the UE, a handover command generated by the target base station according to the handover request preparation message; and
accessing, by the UE, the target cell after the UE receives the handover command.

4. The method according to claim 1, further comprising;
obtaining, by the UE, a parameter configured by the serving base station;
wherein the cell list and the parameter are obtained via one message delivered by the serving base station or the cell list and the parameter are obtained via different messages delivered by the serving base station.

5. The method according to claim 4, wherein the measurement parameter comprises a trigger condition for initiating handover of the UE to a cell in the cell list; and
wherein selecting the cell belonging to the cell list to serve as the target cell is further based on the selected cell meeting the trigger condition.

6. The method according to claim 1, wherein the handover of the UE utilizes, at least one of the following:
handover to the target cell in a random access manner;
direct handover to the target cell;
handover to the target cell including sending of a scheduling request (SR); and
handover to the target cell including sending of a Layer 2 message or a Layer 3 message to the target cell.

7. A user equipment (UE), comprising:
a radio transceiver; and
a processor;
wherein:
the radio transceiver is configured to obtain a cell configured by a serving base station, wherein the cell list comprises at least one cell; and
the processor is configured to perform a cell measurement to obtain a measurement result, to select a cell belonging to the cell list to serve as a target cell based on the measurement result and based on the selected cell being a cell that belongs to the cell list, and to participate in handover of the UE to the target cell.

8. The UE according to claim 7, wherein the radio transceiver is configured to:
send a handover request message to the serving base station, wherein the handover request message comprises a cell identity of the target cell, so as to enable the serving base station to send, according to the cell identity, a handover request preparation message to a target base station corresponding to the target cell.

9. The UE according to claim 8, wherein the radio transceiver is configured to receive a handover command generated by the target base station according to the handover request preparation message; and
the processor being configured to participate in the handover includes the process being configured to access the target cell after the handover command is received.

10. The UE according to claim 7, wherein the radio transceiver is configured to obtain a parameter configured by the serving base station;
wherein the cell list and the parameter are configured to be obtained via one message delivered by the serving base station or the cell list and the parameter are configured to be obtained via different messages delivered by the serving base station.

11. The UE according to claim 7, wherein the processor is configured to:
wherein selecting the cell belonging to the cell list to serve as the target cell is further based on the selected cell meeting a trigger condition.

12. The UE according to claim 7, wherein the handover of the UE is configured to utilize at least one of the following:
handover to the target cell in a random access manner;
direct handover to the target cell;
handover to the target cell including sending of a scheduling request (SR); and
handover to the target cell including sending of a Layer 2 message or a Layer 3 message to the target cell.

13. A base station, wherein the base station is used as a serving base station of a user equipment (UE) and the base station comprises:
a transceiver; and
a processor;
wherein:
the processor is configured to configure a cell list the UE, wherein the cell list comprises at least one cell; and
the transceiver is configured to deliver the cell list the UE, so as to enable the UE to select a cell belonging to the cell list to serve as a target cell for handover of the UE to the target cell, wherein selection of the target cell is based on a measurement result and based on the selected cell being a cell that belongs to the cell list, wherein the measurement result is obtained by the UE based on a cell measurement performed by the UE.

14. The base station according to claim 13, wherein the transceiver is further configured to receive a handover request message sent by the UE, wherein the handover request message is a message sent by the UE to the serving base station after the target cell is obtained, and the handover request message comprises a cell identity of the target cell, and
send, according to the cell identity of the target cell, a handover request preparation message to a target base station corresponding to which the target cell belongs.

15. (canceled)

16. The base station according to claim 13, wherein the transceiver is configured to: send a handover request preparation message to a base station corresponding to a cell in the cell list, and to receive a handover indication message from a target base station corresponding to the target cell, wherein the handover indication message is used to indicate that the UE has accessed the target cell.

17. The base station according to claim 13, wherein the processor being configured to configure the cell list com rises the processor being configured to:
obtain load information of each cell of a plurality of cells,
determine whether load of each cell does not exceed a set load threshold based on the load information, and
add each cell whose load does not exceed the load threshold to the cell list.

18. The method according to claim 5, wherein selecting the cell belonging to the cell list to serve as the target cell is further based on the selected cell having a best measurement result or a highest priority out of multiple cells that belong to the cell list and meet the trigger condition.

19. The UE according to claim 11, wherein selecting the cell belonging to the cell list to serve as the target cell is further based on the selected cell having a best measurement result or a highest priority out of multiple cells that belong to the cell list and meet the trigger condition.
